(19) United States
(12) Patent Application Publication
(10) Pub. No.: US 2003/0122734 A1
(43) Pub. Date: Jul. 3, 2003

(54) Method of driving passive OLED monitor

(76) Inventors: Chih-Chung Chien, Taichung (TW); Yuan-Chieh Lin, Dali City (TW)

Correspondence Address: BIRCH STEWART KOLASCH & BIRCH, PO BOX 747, FALLS CHURCH, VA, 22040-0747, US

(21) Appl. No.: 10/330,174

(22) Filed: Dec. 30, 2002

(30) Foreign Application Priority Data
Dec. 31, 2001 (TW) 090133352

(51) Int. Cl. G09G 3/20

(52) U.S. Cl. 345/55

(57) ABSTRACT

This method of driving a passive OLED monitor makes use of the circuit operating scan line and data line to drive the circuit, disconnects the scan line and the data line from the scan line driven chip and the data line driven chip respectively, lets the scan line driven chip send a scan signal to the scan line, disconnects the scan line and the scan line driven chip when the connection of the scan signal between the scan line and scan line driven chip is interrupted, provides another scan signal to another scan line to connect another scan line and scan line driven chip after the scan line driven chip is delayed.

### FIELD OF THE INVENTION

The present invention relates to a method of driving a passive organic light emitting diode (OLED) monitor, more particularly to a driving method that can solve crosstalk problem and reduce power consumption.

### BACKGROUND OF THE INVENTION

Please refer to FIG. 1 for the diagram of the internal circuit of a prior-art organic light emitting diode (OLED) monitor. Such monitor comprises a plurality of scan lines Com1, Com2, Com3, Com4, and Com5; a plurality of data lines Seg1, Seg2, Seg3, Seg4, and Seg5; and a pixel array; wherein each pixel is an OLED and driven by the corresponding scan line and the corresponding data line. Such monitor also comprises a data line driven chip 12 for providing data signal to the data line, and a scan line driven chip 10 for providing scan signal to scan line according to the sequential scanning method or the interlace scanning method.

The noise of the crosstalk is a factor affecting the screen quality of the prior-art OLED monitor, and easily causes remained image. There are two reasons of generating crosstalk: Firstly, several OLED share a data line and a scan line; secondly, there is no delay time between two scans, so that the electric charge in the data line of the previous scan is remained in the scan line of the next coming scan for electric discharge.

In addition, the non-select status of the data line of the prior-art OLED monitor is low and the non-select status of the scan line is high, which will generate reverse bias voltage or negative bias voltage. Since the reverse bias voltage will produce reverse leakage current, therefore it increases the power consumption of the driving chip and the display panel. If the rectification ratio of the display panel is not good, it will cause the signals to flow disorderly and crosstalk. It is undoubtedly to make the display quality of the monitor even worse, causing the phenomena of uneven brightness and blurred image.

### SUMMARY OF THE INVENTION

The objective of the present invention is to solve the aforementioned crosstalk problem, and in the meantime to reduce the power consumption of the driving chip and display panel.

To accomplish the foregoing objective, the present invention provides a method of driving a passive OLED monitor, comprising the steps of (A) disconnecting the plurality of scan lines and the plurality of the data lines from the scan line driven chip and the data line driven chip respectively; (B) synchronously connecting the scan line and the scan line driven chip when the scan line driven chip provides a scan signal to a scan line; (C) disconnecting the scan line and the scan line driven chip at the moment when the scan signal is interrupted; (D) providing another scan signal to another scan line after the scan line driven chip is delayed for a predetermined time, and synchronously connecting the scan line with the scan line driven chip when the scan line driven chip provides another scan signal; (E) disconnecting said other scan line and said scan line driven chip when said other scan signal is interrupted; and repeating Steps B to E by the scan method of the scan line driven chip until the scan of the plurality of scan lines is completed.

The aforementioned step (C) further comprises the step of synchronously disconnecting the plurality data lines and the data line driven chip at the moment when the scan signal is interrupted.

The step (E) further comprises the step of synchronously disconnecting the plurality of data lines and the data line driven chip at the moment when said other scan signal is interrupted.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG.1 is an internal circuit diagram of the prior-art OLED monitor.

FIG. 2 is a flowchart of the present invention.

FIGS. 3A to 3D are the illustrative diagrams of the operation of the OLED monitor according to a preferred embodiment of the present invention.

FIG. 4 is a waveform diagram of the signals in each scan line and each data line of the OLED monitor of the present invention.

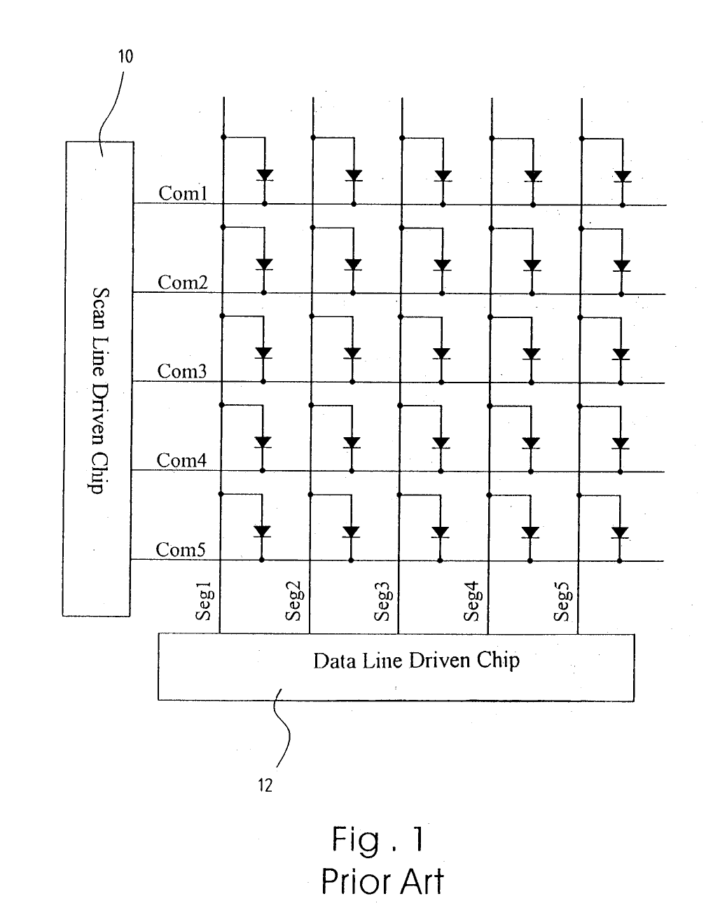

### DETAILED DESCRIPTION OF THE PREFERRED EMBODIMENTS

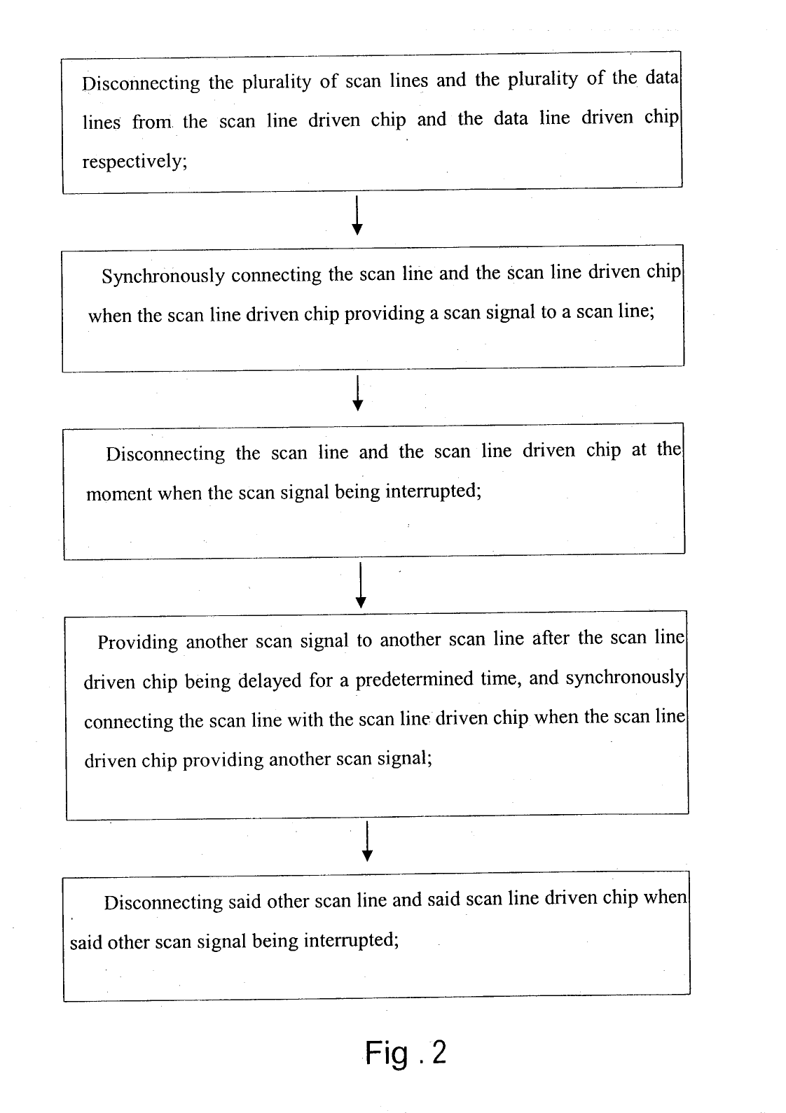

The method of the present invention is disclosed below: Refer to FIG. 2 for the flow chart of the present invention. In the figure, Step 20 is the step of disconnecting the plurality of scan lines and the plurality of the data lines in the monitor from the scan line driven chip 10 and the data line driven chip 12 respectively; Step 22 is the step of synchronously connecting the scan line and the scan line driven chip 10 when the scan line driven chip provides a scan signal to a scan line; Step 24 is the step of disconnecting the scan line and the scan line driven chip 10 at the moment when the scan signal is interrupted; Step 26 is the step of providing another scan signal to another scan line after the scan line driven chip 10 is delayed for a predetermined time, and synchronously connecting the scan line with the scan line driven chip when the scan line driven chip provides another scan signal; Step 28 is the step of disconnecting said other scan line and said scan line driven chip 10 when said other scan signal is interrupted. Steps B to E are repeated according to the scan method of the scan line driven chip 10 until the scan of the plurality of scan lines is completed.

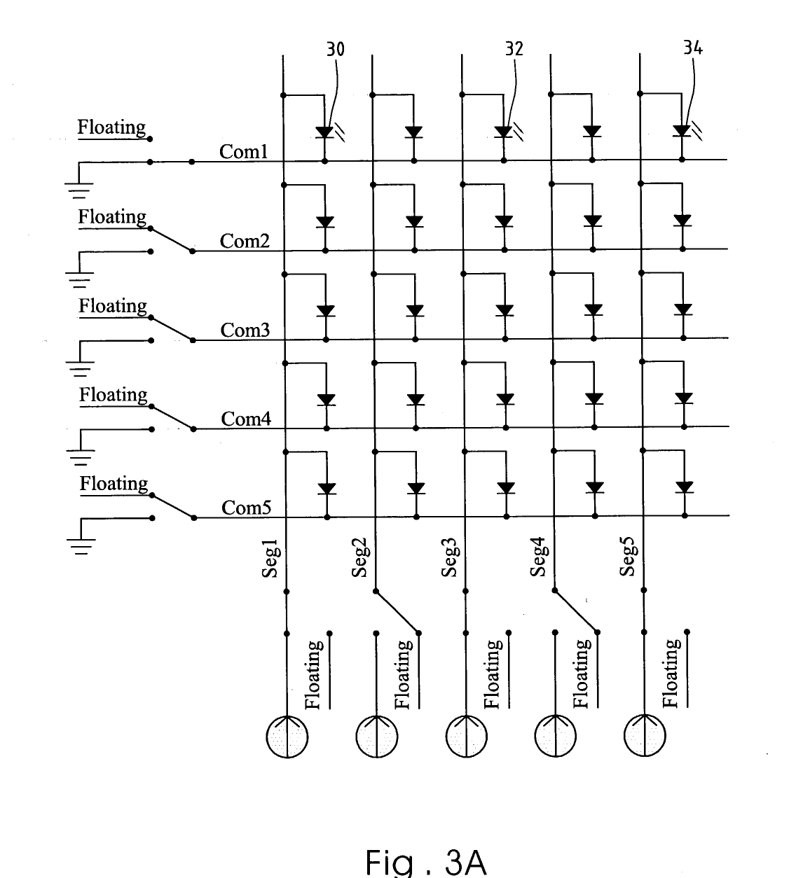

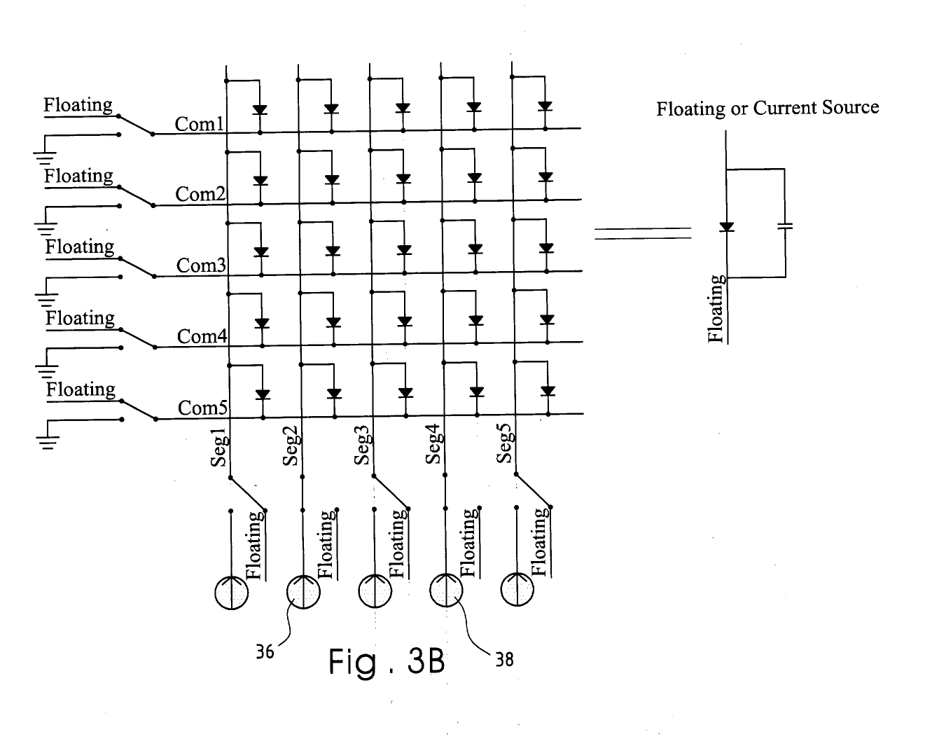

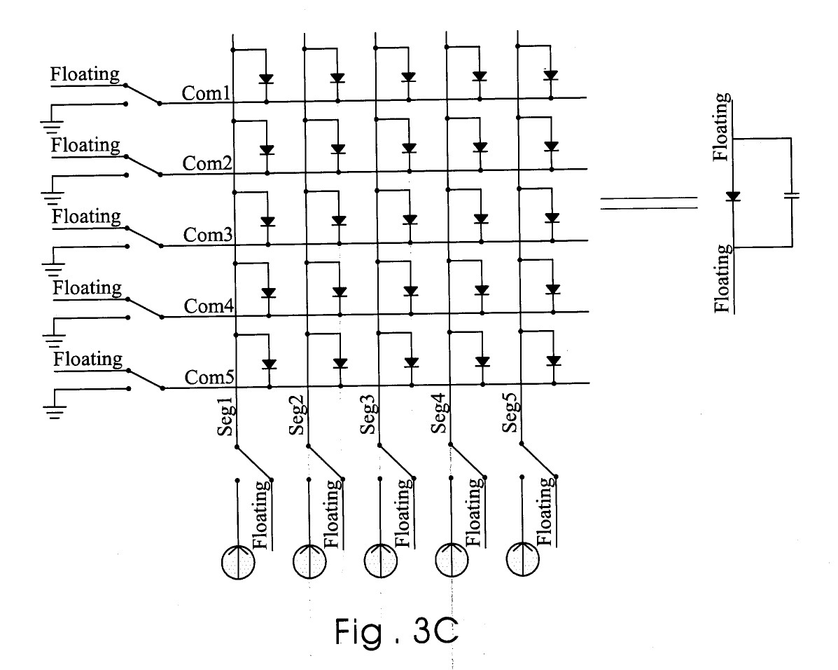

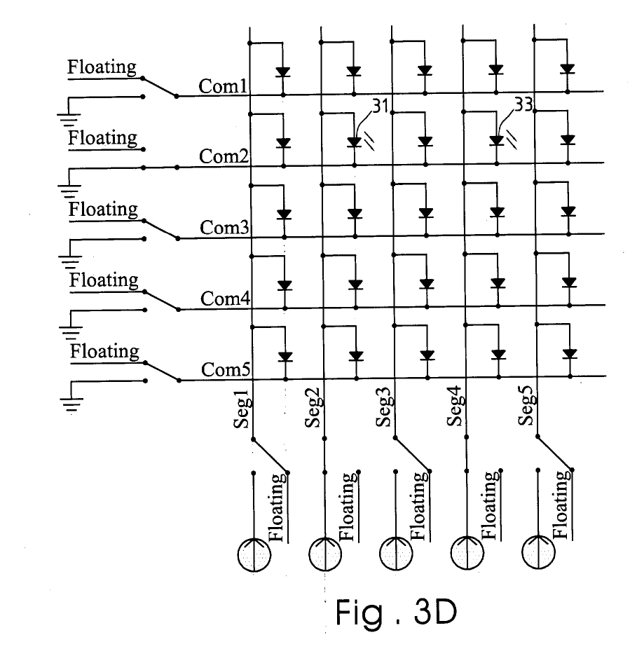

FIGS. 3A to 3D are the illustrative diagrams of the operation of the OLED monitor according to a preferred embodiment of the present invention. FIG. 3A shows that the select condition of the each scan line for the scan line driven chip 10 is low or grounded, and the non-select condition is floating, high impedance, or short-circuit; the select condition of each data line for the data driven chip 12 is high or connected to a current source, and the non-select condition is floating, high impedance, or connected to a current source. The OLED monitor is scanning the scan line COM1, and the OLEDs 30, 32, 34 are driven individually by the data lines Seg 1, Seg 3, Seg 5 for the illumination.

After the OLED monitor completes the scanning of the scan line Com1, the scan line Com1 is switched to non-select condition immediately, which is the status of floating, high impedance, or shirt-circuit as shown in FIG. 3B. At that time, all of the OLED are not driven by the scan line driven chip 10 anymore, but forms a loop. From the view of electricity science, such loop is equivalent to a circuit composing of a LED serially connected with a capacitor. Therefore, such loop can perform the discharge such that the electric charges remained on the data lines Seg1, Seg3, Seg 5 will be discharged automatically from the interior of the display panel, and thus will not generate the aforementioned crosstalk phenomenon. The time for maintaining the situation as illustrated in FIG. 3B should be long enough to totally eliminate the electric charges remained on the scan line, so that the next scan can be taken place. Therefore, the time for maintaining such situation is called “delay time”. The present invention has no intention to emphasize on the select condition of each data line; in other words, the select condition of each data line may remain unchanged or switch to the data select condition of the data line required for next scan (as shown in FIG. 3B). Of course, all data lines may also be switched to the non-select condition (as shown in FIG. 3C), since each OLED can form a loop and will not be affected by the externally connected circuit. Even the driving current produced by the current sources 36, 38 as shown in FIG. 3B, such current will not flow into the loop, or have any impact.

FIG. 3D shows that the OLED monitor is scanning the scan line Com2, and the OLEDs 31, 33 are driven individually by the data lines Seg2, Seg4 for illumination. The present invention repeats the foregoing “Select—Non-Select—Delay” procedure according to the scanning method of the scan line driven chip 10. If it is described from the viewpoint of the circuit, it is considered as repeating the “connection—short-circuit—delay” procedure until the scanning of all scan lines is completed.

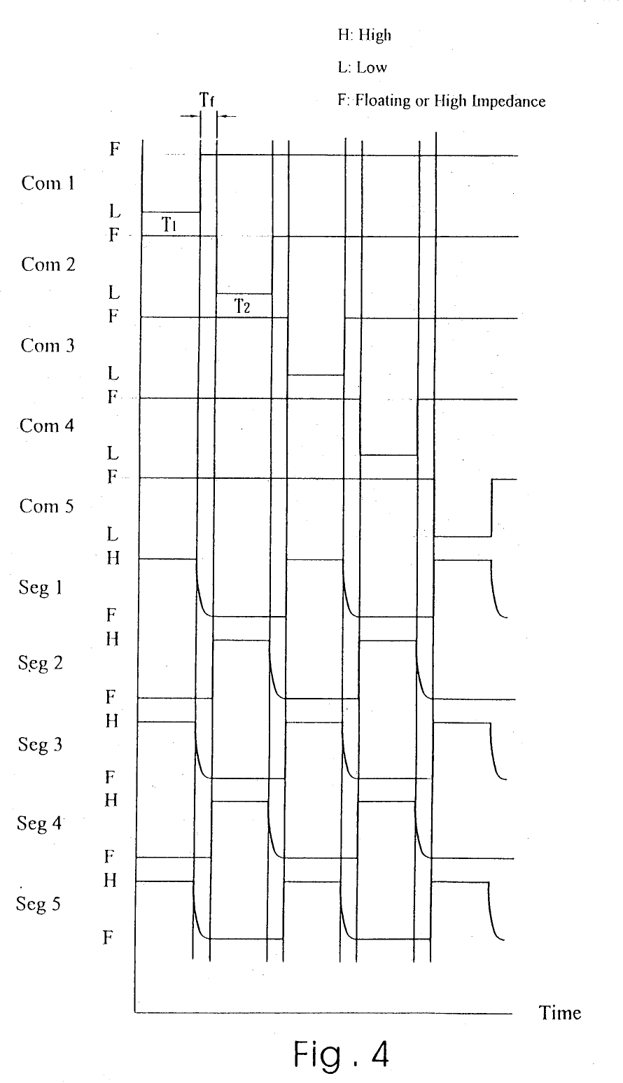

Refer to FIG.4 for the OLED monitor, and the signal waveform diagram of each scan line and each data line of the present invention. In the figure, the scan line driven chip 10 provides scan signals individually to the scan lines Com1, Com2, Com3, Com4, Com5 by the sequential scanning method. However, the present invention is not an OLED monitor limited to the sequential scanning method for the scanning, and other methods such as the interlace scanning method can be used as well. In the timing section T1, the data line driven chip 12 simultaneously provides data signal to the data lines Seg1, Seg3, Seg5, and such data signal is the driving current. In a short timing section Tf, which is the aforementioned delay time, the electric charges remained on the data lines Seg1, Seg3, Seg5 will be discharged from the interior of the display panel. In the timing section T2, the next scan line Com2 is scanned.

The features of the present invention can be summarizes as follows: The “delay time” design is employed to give sufficient time to fully discharge the electric charges remained on the data lines, and thus will not generate crosstalk.

The non-select potential of the scan line and data line are floating, high impedance, or short-circuit, therefore it will not produce reverse bias voltage or negative bias voltage, and thus will not produce reverse leakage current. Therefore, the current outputted by the driving chip can be totally eliminated from the display panel, and such arrangement can reduce the power consumption of the driving chip and the display panel.

The passive OLED monitor according to the present invention will not produce reverse leakage current, and thus the signal will not flowed disorderly or produce crosstalk even the rectification of the display panel is not good.

The present invention can be put into practice very easily by the circuit design, of which a transistor switch can be used to control the connection and disconnection of the data line and data line driven chip and the connection and disconnection of the data line and data line driven chip; a trigger with delay time setting can be used to maintain the short-circuit condition between the data line and data line driven chip and the short-circuit condition between the scan line and scan line driven chip.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method of driving a passive OLED monitor, wherein the monitor comprising a plurality of scan lines, a plurality of data lines, a plurality of OLED driven by the plurality of scan lines and the plurality of data lines, a data line driven chip for providing data signal to the data line, and a scan line driven chip for providing a scan signal to the scan line according to a scan method, and said driving method comprising the steps of:
(A) disconnecting the plurality of scan lines and the plurality of the data lines from the scan line driven chip and the data line driven chip respectively;
(B) synchronously connecting the scan line and the scan line driven chip when the scan line driven chip providing a scan signal to a scan line;
(C) disconnecting the scan line and the scan line driven chip at the moment when the scan signal being interrupted;
(D) providing another scan signal to another scan line after the scan line driven chip being delayed for a predetermined time, and synchronously connecting the scan line with the scan line driven chip when the scan line driven chip providing another scan signal;
(E) disconnecting said other scan line and said scan line driven chip when said other scan signal being interrupted; and repeating Steps B to E by a scan method of the scan line driven chip until the scan of the plurality of scan lines being completed.

2. The method of driving a passive OLED monitor as claimed in claim 1, wherein said step (C) further comprising the step of synchronously disconnecting the plurality data lines and the data line driven chip at the moment when the scan signal being interrupted.

3. The method of driving a passive OLED monitor as claimed in claim 1, wherein said step (E) further comprises the step of synchronously disconnecting the plurality of data lines and the data line driven chip at the moment when said other scan signal being interrupted.

4. The method of driving a passive OLED monitor as claimed in claim 1, wherein said scan method is a sequential scan method.

5. The method of driving a passive OLED monitor as claimed in claim 1, wherein said scan method is an interlace scan method.
